(19) United States
(12) Patent Application Publication
(10) Pub. No.: US 2018/0301971 A1
(43) Pub. Date: Oct. 18, 2018

(54) RING-SHAPED BONDED MAGNET, VOICE COIL MOTOR AND METHOD OF MANUFACTURING VOICE COIL MOTOR

(71) Applicant: HITACHI METALS, LTD., Tokyo (JP)

(72) Inventor: Yoshihiko KURIYAMA, Takasaki-shi (JP)

(21) Appl. No.: 15/951,018

(22) Filed: Apr. 11, 2018

(30) Foreign Application Priority Data
Apr. 14, 2017 (JP) 2017-80175

(51) Int. Cl. H02K 41/035; H02K 1/14; H02K 1/18

(52) U.S. Cl. CPC H02K 41/0356; H02K 1/17; H02K 1/185; H02K 1/146

(57) ABSTRACT

A voice coil motor includes a disk-shaped lower yoke, three columnar pole yokes provided on one surface of the lower yoke, a integrally molded ring-shaped bonded magnet having three hole portions into which the pole yokes are inserted, an upper yoke having three hole portions into which the pole yokes are inserted at positions circumferentially aligned with the hole portions of the ring-shaped bonded magnet, three cylindrical coils into which the respective poles yokes are inserted, and a coil support supporting the coils. The ring-shaped bonded magnet is configured such that parts of the outer surfaces of the three ring magnets equally placed in a circumferential direction are integrally joined.

### CROSS-REFERENCE TO RELATED APPLICATIONS

This non-provisional application claims priority under 35 U.S.C. § 119(a) on Patent Application No. 2017-80175 filed in Japan on Apr. 14, 2017, the entire contents of which are hereby incorporated by reference.

### FIELD

The present invention relates to a ring-shaped bonded magnet used for a voice coil motor to be employed for a driving mechanism, a voice coil motor using the ring-shaped bonded magnet and a method of manufacturing the voice coil motor.

### BACKGROUND

For a magnetic disk device, a voice coil motor is employed as a driving source for driving an actuator mounted with a magnetic head.

The voice coil motor includes a coil-movable-typed voice coil motor disclosed in Japanese Patent Application Laid-Open No. 1989-107646 and Japanese Patent Application Laid-Open No. 1991-150061, for example, in which by the combined use of a stator having a cylindrical magnet fixed on the internal surface of a cylindrical yoke and a mover including a core on which a coil is wound, the mover is inserted into the stator with a predetermined clearance between the magnet and the coil.

Such a voice coil motor is desired to increase in thrust upon upsizing of the equipment to be driven. Note that upsizing of the voice coil motor itself is not desired at this time.

In Japanese Patent Application Laid-Open No. 2010-154649, a magnet-movable-typed linear motor capable of providing great thrust with compact configuration is proposed. In such a linear motor, plurality of linear motors each of which is formed by a prism stator and a cylindrical mover in a pair are coupled in up and down, left and right directions orthogonal to the direction of thrust. The stator is configured to include magnets fixed on the inner peripheral surface of a yoke inserted into a holder while the mover is configured to include a core which is disposed in the outer periphery of the cylindrical frame and on which a coil is wound.

### SUMMARY

The linear motor disclosed in Patent Application Laid-Open No. 2010-154649, however, is manufactured by first separately manufacturing each of the plurality of stators, assembling these stators coupled in parallel and then inserting a mover into each of the stators. This arises problems of complicated structure as well as complexity of the manufacturing process and high cost inevitably involved.

A sintered magnet is often used for such a voice coil motor but it has less design flexibility since the form depends on whether a metal mold can be fabricated or not.

Furthermore, in order to increase the thrust generated by the voice coil motor by a factor of two or more, the same structures arranged in parallel have to be coupled to one output axis, or current applied to the coil of the voice coil motor has to be increased by a factor of two or more. In the former method, more components to be installed are required for arranging a plurality of voice coil motors in parallel, which may increase the physical size of the entire device. In the latter method, since a coil is generally not designed to allow 2-fold or higher current to flow, this may cause the temperature rise of a coil and an electrical breakdown, which may shorten the lifetime of a coil.

The present invention is made in view of the above-described problems, and aims at provision of a ring-shaped bonded magnet integrally joined with a plurality of ring magnets and used for a stator of the voice coil motor capable of providing great thrust with a compact configuration while having a simple structure with less components and easiness of manufacturing, a voice coil motor and a method of manufacturing the voice coil motor.

A ring-shaped bonded magnet according to the present invention is a ring-shaped bonded magnet used for a stator of a voice coil motor and is characterized in that parts of outer surfaces of at least two ring magnets are configured to be integrally joined.

According to the present invention, an integrally-molded-typed ring-shaped bonded magnet in which parts of the outer surfaces of at least two ring magnets are integrally joined is used for a stator of the voice coil motor. This makes it possible to easily construct a parallel-connected stator without assembling multiple stators like a conventional art and facilitate the manufacturing of the voice coil motor.

A ring-shaped bonded magnet according to the present invention is a ring-shaped bonded magnet used for a stator of a voice coil motor and is characterized in that parts of outer surfaces of three ring magnets equally placed in a circumferential direction are configured to be integrally joined.

According to the present invention, an integrally-molded-typed ring-shaped bonded magnet in which parts of the outer surfaces of three ring magnets equally placed in a circumferential direction are integrally joined is used for a stator of the voice coil motor. This makes it possible to easily construct a triple-connected stator without assembling multiple stators like the conventional art and facilitate the manufacturing of the voice coil motor. The configuration with three poles makes less deflection.

The ring-shaped bonded magnet according to the present invention is characterized in that laminate molding using a 3D printer, compression molding or injection molding is employed for fabrication.

According to the present invention, the integrally-molded-typed ring-shaped bonded magnet is fabricated by laminate molding using a 3D printer, compression molding or injection molding. This makes it possible to easily fabricate an integrally-molded-typed ring-shaped bonded magnet having a predetermined shape. Meanwhile, a sintered magnet allows for fabrication of a simple ring shape, but it does not allow for fabrication of a ring shape in which parts of multiple ring magnets are joined with each other and does not fit for the present invention.

A voice coil motor according to the present invention is characterized in that it comprises a disk-shaped first yoke: a plurality of columnar second yokes provided on one surface of the first yoke; an integrally molded ring-shaped bonded magnet having a plurality of hole portions into which the second yokes are inserted; a third yoke having a plurality of hole portions into which the second yokes are inserted at positions circumferentially aligned with the hole portions of the ring-shaped bonded magnet; a plurality of cylindrical coils into which the respective second yokes are inserted; and a supporter supporting the coils.

In the voice coil motor according to the present invention, a stator configured to laminate a disk-shaped first yoke provided with a plurality of columnar second yokes on one surface of the first yoke, an integrally-molded-typed ring-shaped bonded magnet into which the second yokes are inserted, and a third yoke into which the second yokes are inserted is combined with a mover configured to support, by a supporter, a plurality of coils into which the respective second yokes are inserted. Since a plurality of magnetic circuits are arranged in parallel, this may provide great thrust even with compact and simple structure. Furthermore, since an integrally-molded-typed ring-shaped bonded magnet is configured to be used for a stator, it eliminates the need for assembling like the conventional art, and allows for configuration of a parallel-connected stator with ease. Thus, simplification and cost reduction of the manufacturing of the voice coil motor may be achieved.

The voice coil motor according to the present invention is characterized in that it further comprises a cover that is provided on an outer surface side of the ring-shaped bonded magnet.

The voice coil motor according to the present invention is provided with the cover on the outer surface side of the integrally-molded-typed ring-shaped bonded magnet. This makes it possible to protect the ring-shaped bonded magnet.

The voice coil motor according to the present invention is characterized in that it further comprises a connecting member that connects the first yoke and the third yoke.

In the voice coil motor according to the present invention, the first yoke and the third yoke are connected by the connecting member. Thus, it is possible to surely fix the integrally-molded-typed ring-shaped bonded magnet sandwiched between the first yoke and the third yoke.

A method of manufacturing a voice coil motor according to the present invention is characterized in that a stator configured such that a plurality of columnar second yokes provided on one surface of a disk-shaped first yoke are inserted into a plurality of hole portions of an integrally molded ring-shaped bonded magnet and a plurality of hole portions of a third yoke at positions circumferentially aligned with the hole portions of the ring-shaped bonded magnet is disposed relative to a mover configured to support a plurality of cylindrical coils by a supporter such that the second yokes are inserted into the coils with the coils movable.

In the present invention, since a parallel-connected magnetic circuit is configured by using for the stator the integrally-molded-typed ring-shaped bonded magnet in which parts of the outer surfaces of at least two ring magnets are integrally joined, the voice coil motor capable of providing great thrust with compact and simple structure may be provided. Since a parallel-connected magnetic circuit is configured without assembling multiple magnetic circuits like the conventional art, the voice coil motor may easily be manufactured. Consequently, curtailment of the manufacturing processes and reduction in the manufacturing cost may be achieved. Furthermore, the use of laminate molding using a 3D printer for manufacturing the ring-shaped bonded magnet eliminates the need for fabricating a metal mold. This makes it possible to make a prototype and performance evaluation of a voice coil motor in a short period of time as well as at a low price and to curtail the time period for developing a new voice coil motor.

The above and further objects and features will more fully be apparent from the following detailed description with accompanying drawings.

### BRIEF DESCRIPTION OF THE DRAWINGS

FIG. 1 is a perspective view illustrating a voice coil motor according to the present invention.

FIG. 2 is an exploded perspective view illustrating the voice coil motor according to the present invention.

FIG. 3 is a cross-sectional view illustrating the voice coil motor according to the present invention.

FIG. 4A is a perspective view illustrating a stator and a mover of the voice coil motor according to the present invention.

FIG. 4B is a perspective view illustrating a stator and a mover of the voice coil motor according to the present invention.

FIG. 5A is a perspective view illustrating an integrally-molded-typed ring-shaped bonded magnet used for the stator of the voice coil motor according to the present invention.

FIG. 5B is a plan view illustrating an integrally-molded-typed ring-shaped bonded magnet used for the stator of the voice coil motor according to the present invention.

FIG. 6 is a plan view illustrating another example of an integrally-molded-typed ring-shaped bonded magnet.

FIG. 7 is a plan view illustrating another example of an integrally-molded-typed ring-shaped bonded magnet.

FIG. 8 is a plan view illustrating another example of an integrally-molded-typed ring-shaped bonded magnet.

### DETAILED DESCRIPTION

The present invention will be described with reference to the drawings of embodiments.

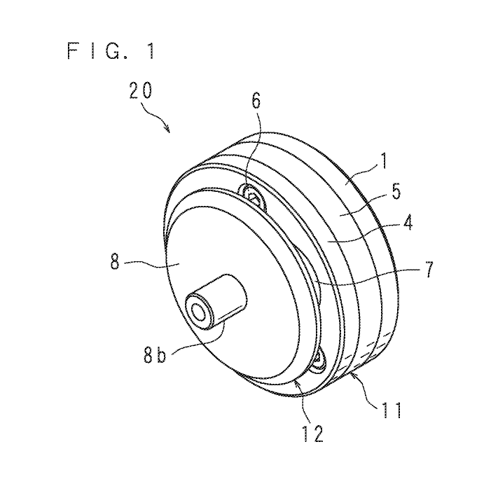

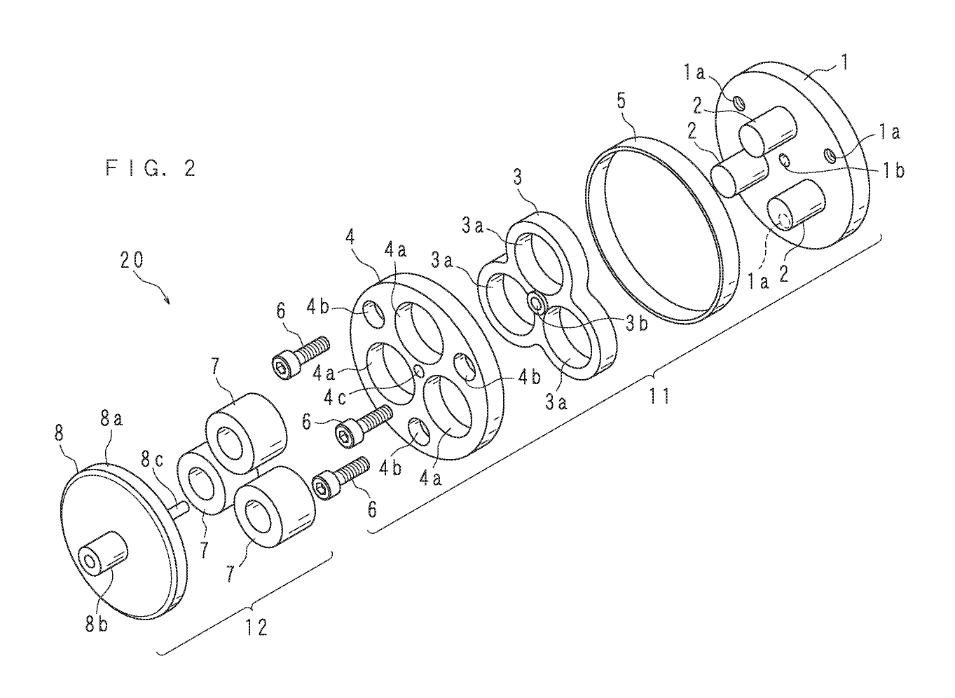

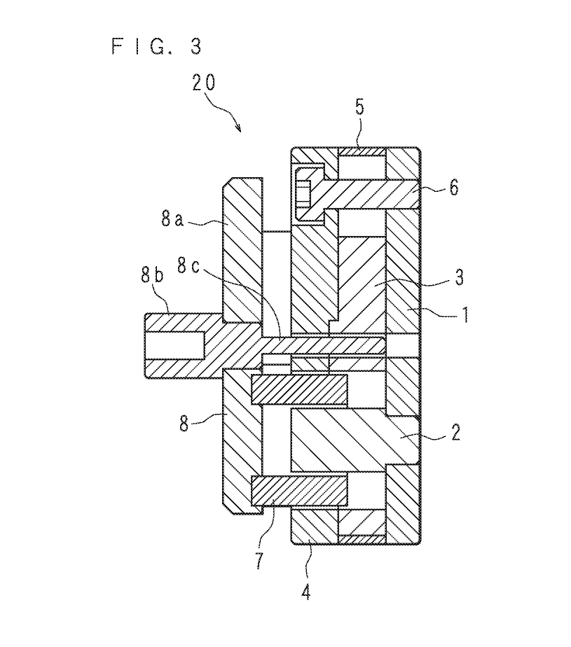

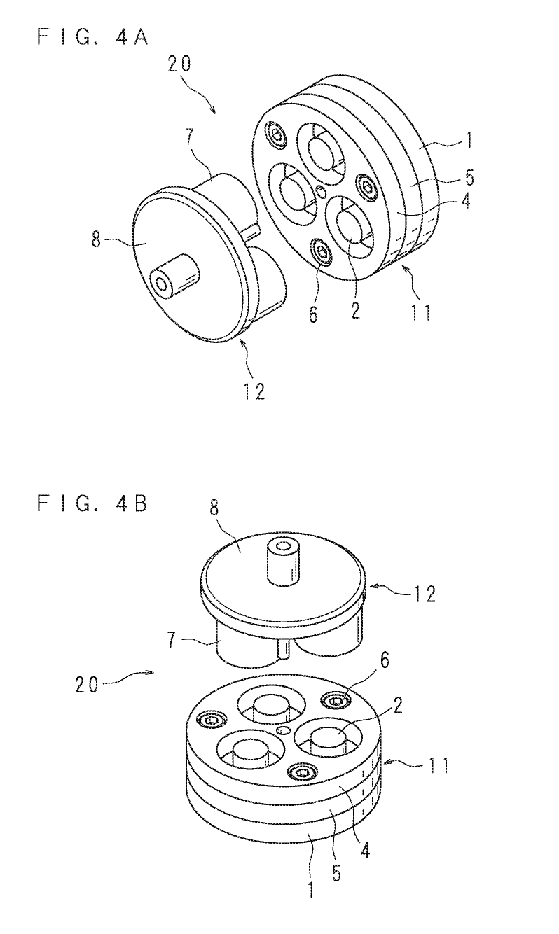

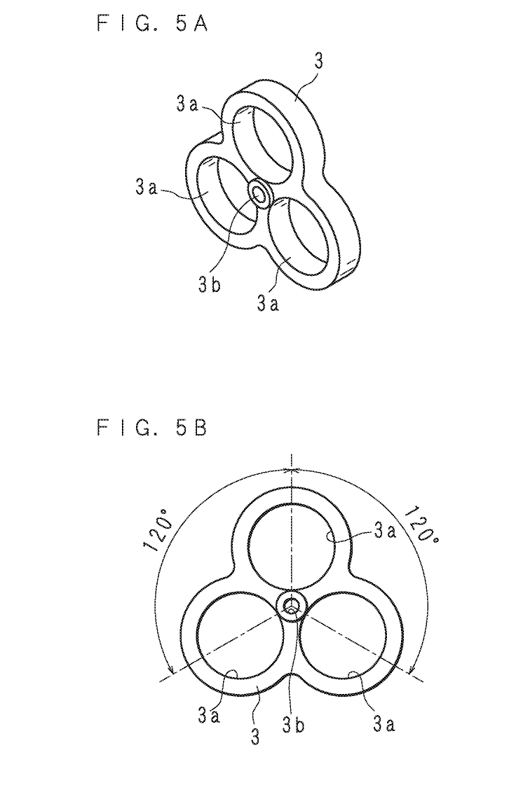

FIG. 1, FIG. 2 and FIG. 3 are respectively a perspective view, an exploded perspective view and a cross-sectional view of a voice coil motor according to the present invention. FIG. 4 A and FIG. 4B are perspective views illustrating a stator and a mover of the voice coil motor according to the present invention, FIG. 5A and FIG. 5B are respectively a perspective view and a plan view of the integrally-molded-typed ring-shaped bonded magnet used for the stator of the voice coil motor according to the present invention.

A voice coil motor 20 according to the present invention is constructed by a stator 11 and a mover 12 in combination.

The stator 11 includes a lower yoke 1 regarding as a first yoke, three pole yokes 2 regarding as second yokes, an integrally-molded-typed ring-shaped bonded magnet 3, an upper yoke 4 regarding as a third yoke, a cover 5, and three bolts 6 regarding as a connecting member. A nonmagnetic type is used for the bolt 6 regarding as the connecting member. A magnetic bolt is also usable, but the bolt may cause shorting of a magnetic path, resulting in reduction of the efficiency. Thus, the use of a nonmagnetic bolt is preferable.

The lower yoke 1 is disk-shaped. On an inside surface of the lower yoke 1, three columnar pole yokes 2 are provided upright equally in the circumferential direction of the lower yoke 1. The lower yoke 1 and the pole yokes 2 are made of a soft magnetic material such as a silicon steel plate. At the intermediate positions between the adjacent pole yokes 2, 2 and equally spaced in the circumferential direction of the lower yoke 1, three bolt holes 1a are formed. The bolt 6 is fit into each of the bolt holes 1a. At the center of the lower yoke 1, a central hole 1b is formed. A shaft 8c of the mover 12 described later is inserted into the central hole 1b.

The integrally-molded-typed ring-shaped bonded magnet 3 is constructed such that parts of the outer surfaces of three ring magnets equally placed in the circumferential direction are integrally joined to each other, and is cloverleaf-shaped in plan view as illustrated in FIGS. 5A and 5B. The ring-shaped bonded magnet 3 includes three hole portions 3a equally spaced in the circumferential direction. One pole yoke 2 is inserted into each of the hole portions 3a. Furthermore, at the center of the ring-shaped bonded magnet 3, a central hole 3b is formed. The shaft 8c is inserted into the central hole 3b. The ring-shaped bonded magnet 3 is magnetized in the direction of thickness (the right and left direction in FIG. 3).

The ring-shaped bonded magnet 3 is resin-bonded-typed magnet that is made of a mixture of magnetic powder of an SmFeN alloy and resin and is fabricated by laminate molding (3D printing) using a 3D printer. The 3D printing enables fabrication of the ring-shaped bonded magnet 3 by extruding and laminating the mixture of magnetic powder and resin from a nozzle to a mounting stand while relatively moving the nozzle and the mounting stand in a three-dimensional manner in order to obtain a desired shape.

The upper yoke 4 is disk-shaped. The upper yoke 4 is provided with three hole portions 4a spaced equally in the circumferential direction. These hole portions 4a are circumferentially aligned with the hole portions 3a of the ring-shaped bonded magnet 3, and into each of the hole potions 4a, one pole yoke 2 is inserted. At the intermediate positions between the adjacent hole portions 4a, 4a and equally spaced in the circumferential direction of the upper yoke 4, three bolt holes 4b are formed. The bolt 6 is fit into each of the bolt holes 4b. At the center of the lower yoke 4, a central hole 4c is formed. The shaft 8c is inserted into the central hole 4c. The upper yoke 4 is made of a soft magnetic material such as a silicon steel plate.

The cover 5 has a thin cylindrical shape, and is disposed to cover the outer surface of the ring-shaped bonded magnet 3. The cover 5 is made of nonmagnetic metal such as aluminum. The cover 5 functions as a protector of the ring-shaped bonded magnet 3.

The mover 12 includes three cylindrical coils 7 and a coil support 8 regarding as a supporter. The coil support 8 is made of a nonmagnetic material such as aluminum.

The coil 7 is constructed such that a copper wire, for example, is wound into a cylindrical form. One pole yoke 2 is inserted into each coil 7 through the hole portion 4a of the upper yoke 4 and the hole portion 3a of the ring-shaped bonded magnet 3. Here, the coil. 7 is disposed so as to move in the axial direction of the voice coil motor 20 through the hole portion 4a and the hole portion 3a.

The coil support 8 is formed by a disk-like body part 8a, a cylindrical part 8b extending from the front surface of the body part 8a at the center thereof and a shaft 8c extending from the rear surface of the body part 8a at the center thereof. The coil support 8 supports the coils 7 by the rear surface. The shaft 8c is inserted into the central hole 4c of the upper yoke 4, the central hole 3b of the ring-shaped bonded magnet 3 and the central hole 1b of the lower yoke 1 so as to be movable in the axial direction of the voice coil motor 20.

The following describes a method of manufacturing the voice coil motor 20 according to the present invention.

The stator 11 is constructed by laminating the lower yoke 1 structured as described above, the ring-shaped bonded magnet 3 with the outer surface covered by the cover 5 and the upper yoke 4 in this order, and fitting the bolts 6 into the bolt holes 4b of the upper yoke 4 and the bolt holes 1a of the lower yoke 1 (see FIGS. 4a and 4B). At this time, the pole yokes 2 are inserted into the hole portions 3a of the ring-shaped bonded magnet 3 and the hole portions 4a of the upper yoke 4. By tightening the bolts 6, the ring-shaped bonded magnet 3 is securely fixed.

Meanwhile, the mover 12 is constructed with three coils 7 supported by the coil support 8 (see FIGS. 4A and 4B).

The voice coil motor 20 is then assembled by inserting the shaft 8c of the coil support 8 into the central hole 4c of the upper yoke 4, the central hole 3b of the ring-shaped bonded magnet 3 and the central hole 1b of the lower yoke 1 (see FIG. 1). At this time, the pole yokes 2 are inserted into the coils 7 through the hole portions 4a of the upper yoke 4 and the hole portions 3a of the ring-shaped bonded magnet 3 in such a manner that the mover 12 (coil and coil support 8) is movable in the axial direction of the voice coil motor 20.

Since the voice coil motor 20 described above is structured to arrange three magnetic circuits in parallel, this may provide great thrust with less components and compact structure without being long in dimension.

Since the integrally molded ring-shaped bonded magnet 3 is used, it is only required that one ring-shaped bonded magnet 3 is fabricated for the voice coil motor 20 according to the present invention. Hence, the present invention can more simplify the manufacturing process than the case where a stator is constructed by individually fabricating plurality of ring magnets and then assembling the fabricated plurality of ring magnets in parallel. As a result, the present invention may curtail the manufacturing time and the manufacturing cost.

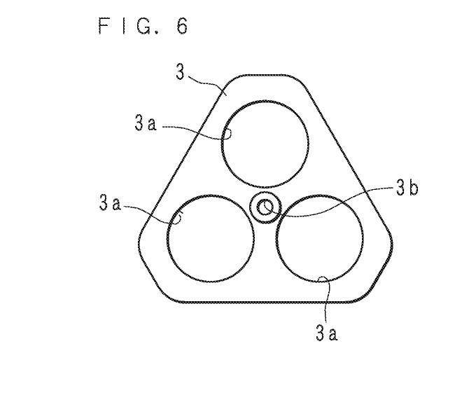

The integrally-molded-typed ring-shaped bonded magnet 3 used for the stator 11 of the voice coil motor 20 described above is cloverleaf-shaped in which parts of the outer surfaces of the three ring magnets equally placed in the circumferential direction are integrally joined to each other, but the integrally-molded-typed ring-shaped bonded magnet 3 to be used is not limited thereto. FIGS. 6 to 8 are plan views illustrating other examples of the integrally-molded-typed ring-shaped bonded magnet 3.

The integrally-molded ring-shaped bonded magnet 3 illustrated in FIG. 6 is substantially triangular in which parts of the outer surfaces of the three ring magnets equally placed in the circumferential direction are integrally joined to each other. Since this example can make the cross-sectional area of the peripheral part and the volume larger than those of the clover-leaf shaped example as described above, a further increase in thrust is expected. This example is structured to include a magnet in which parts of the outer surfaces of the three ring magnets equally placed in the circumferential direction are integrally joined, and thus, the effect produced by the present invention can be obtained.

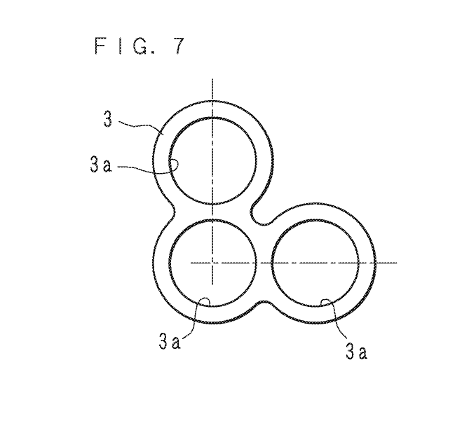

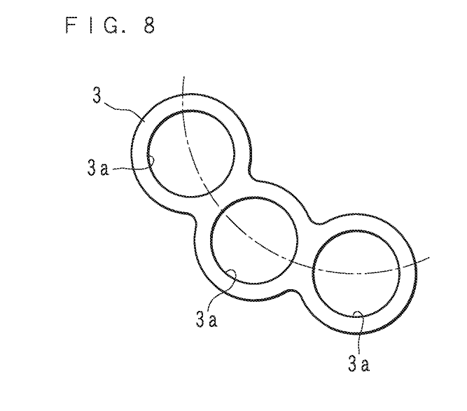

The integrally-molded-typed ring-shaped bonded magnet 3 illustrated in FIG. 7 is L-shaped in which parts of the outer surfaces of three adjacent ring magnets are integrally joined to each other. Furthermore, the integrally-molded-typed ring-shaped bonded magnet 3 illustrated in FIG. 8 is arc-shaped in which parts of the outer surfaces of three adjacent ring magnets are integrally joined to each other. The irregular ring-shaped bonded magnet 3 as illustrated in FIG. 7 or FIG. 8 is preferable when a specific-shaped (shape different from that of the voice coil motor 20 illustrated in FIG. 1) voice coil motor is required to be installed at a specific-shaped space due to the limited instillation space of the voice coil motor.

Note that in the above-described embodiment, one integrally-molded-typed ring-shaped bonded magnet 3 is used for the stator 11. However, unlikely thereto, multiple integrally-molded-typed ring-shaped bonded magnets 3 may be sandwiched in series between the upper yoke 4 and the lower yoke 1 to form a stator 11. By laminating multiple ring-shaped bonded magnets 3, greater thrust can be provided.

In the above-described embodiment, the integrally-molded-typed ring-shaped bonded magnet 3 is constructed in such a manner that three ring magnets are integrally joined to each other. However, unlikely thereto, the integrally-molded-typed ring-shaped bonded magnet 3 in which parts of the outer surface of two, four or more ring magnets may be integrally joined may be used. In this case, it may take the same shape as that of the voice coil motor 20 in FIG. 1 or may take a different shape conforming to the shape of the magnets.

In addition, in the above-described embodiment, the mixture of magnetic powder of SmFeN alloy and resin are used to fabricate the integrally-molded-typed ring-shaped bonded magnet 3. However, unlikely thereto, ferrite magnetic powder or magnetic powder of NdFeB alloy may be used.

Moreover, in the above-described embodiment, 3D printing is employed to fabricate the integrally-molded-typed ring-shaped bonded magnet 3. However, unlikely thereto, compression molding or injection molding may be used to fabricate the integrally-molded-typed ring-shaped bonded magnet 3.

It is to be noted that, as used herein and in the appended claims, the singular forms “a”, “an”, and “the” include plural referents unless the context clearly dictates otherwise.

The embodiments disclosed this time are examples in all respects, and should be considered to be not restrictive. The scope of the present invention is not limited to the above-described meaning but is indicated by the claims, and it is intended that all modifications within the meaning and scope equivalent to the claims are included.

What is claimed is:

1. A ring-shaped bonded magnet used for a stator of a voice coil motor, wherein parts of outer surfaces of at least two ring magnets are configured to be integrally joined.

2. The ring-shaped bonded magnet according to claim 1, wherein laminate molding using a 3D printer, compression molding or injection molding is employed for fabrication.

3. A ring-shaped bonded magnet used for a stator of a voice coil motor, wherein parts of outer surfaces of three ring magnets equally placed in a circumferential direction are configured to be integrally joined.

4. The ring-shaped bonded magnet according to claim 3, wherein laminate molding using a 3D printer, compression molding or injection molding is employed for fabrication.

5. A voice coil motor; comprising:
a disk-shaped first yoke;
a plurality of columnar second yokes provided on one surface of the first yoke;
an integrally molded ring-shaped bonded magnet having a plurality of hole portions into which the second yokes are inserted;
a third yoke having a plurality of hole portions into which the second yokes are inserted at positions circumferentially aligned with the hole portions of the ring-shaped bonded magnet;
a plurality of cylindrical coils into which the respective second yokes are inserted; and
a supporter supporting the coils.

6. The voice coil motor according to claim 5, further comprising a cover that is provided on an outer surface side of the ring-shaped bonded magnet.

7. The voice coil motor according to claim 5, further comprising a connecting member that connects the first yoke and the third yoke.

8. A method of manufacturing a voice coil motor, comprising:
forming a stator by inserting a plurality of columnar second yokes provided on one surface of a disk-shaped first yoke through a plurality of hole portions of an integrally molded ring-shaped bonded magnet and a plurality of hole portions of a third yoke circumferentially aligned with the hole portions of the ring-shaped bonded magnet; and
disposing a mover configured to support a plurality of cylindrical coils by a supporter relative to the stator such that the second yokes are inserted into the coils with the coils movable.
